(19) United States
(12) Patent Application Publication
(10) Pub. No.: US 2008/0183512 A1
(43) Pub. Date: Jul. 31, 2008

(54) SYSTEM AND METHOD FOR ESTIMATING SEAT VALUE

(75) Inventors: Michael A. Benzinger, Dallas, TX (US); Lorenzo Laohoo, Keller, TX (US); Jagdeep S. Sandhu, Grapevine, TX (US); Barry C. Smith, Flower Mound, TX (US); Yanjun Zhang, Plano, TX (US); Faker Zouaoui, Irving, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sabre, Inc.

(21) Appl. No.: 11/627,684

(22) Filed: Jan. 26, 2007

(51) Int. Cl. G01C 21/36

(52) U.S. Cl. 705/6

(57) ABSTRACT

A system, method, and computer-readable medium for generating an itinerary in response to a request from a user are provided. For example, the system includes a memory comprising a fare table, wherein the fare table includes a plurality of travel markets each associated with a fare and at least one rule. The system also includes at least one processing element configured to estimate a seat value for at least one itinerary comprising at least one flight in response to a request from a user. Each estimated seat value is based on at least one fare within the fare table that satisfies at least one associated rule within the fare table.

### BACKGROUND OF THE INVENTION

1) Field of the Invention

Embodiments of the present invention relate to shopping requests and, more particularly, to systems and methods for organizing and applying rules, fares, and availability to process travel-related shopping requests.

2) Description of Related Art

Reservation systems and Internet fare search engines use specialized techniques to review fare offerings, both published and unpublished (i.e., specially offered fares not normally available), across a number of different vendors (e.g., airlines, car rental companies, hotels, and the like) and return these results to the buyer in some ranked ordering based on the attributes the customer has requested, such as by price. Each travel vendor's system allows the fare search engines to determine which of their fares are available for the dates and itinerary being considered, and the fare search engines sort and select the best alternatives. The objective of traditional fare search processing is to find the best fare offers available in the marketplace.

However, processing air shopping requests is a difficult problem to solve efficiently and requires simultaneous scrutiny of many factors that span flight schedules, availability, published fares, rule restrictions, and complex business logic. The order in which the variables are analyzed has evolved with varying degrees of success while continuously emphasizing the need for more efficient techniques for processing requests. The looming competitive pressures that encompass temporal functionality, such as calendar shopping, continue to expand the search space, require additional resources, and increase response time of air shopping.

One of the primary partitions of the business data is the vast array of fares and rules that describe the price of service across pieces of a huge market network with well described restrictions. Traditional thinking emphasizes a sequence of origination-destination objects formed from either schedules or fares. An inherent challenge to the shopping problem space is managing volumes of data objects that must be directly accessed, cross-referenced, or traversed to process a specific transaction. These tasks are not trivial and demand considerable effort in real-time, caching, and database persistence that ultimately ebb overall performance.

Furthermore, in an effort to reduce the volume of real-time availability requests, an availability cache may be used to store the results of seat availability requests in a database for potential re-use in shopping requests. Different techniques may be used to update the data in an availability cache for accuracy. Despite the burden alleviated on the airlines for providing seat availability, additional innovations beyond the improvement resulting from the use of an availability cache are needed to alleviate some of the burden on the airlines for processing low-fare shopping requests.

Therefore, it would be advantageous to provide techniques for organizing and applying availability, rules, and fares to more efficiently process shopping requests. In addition, it would be advantageous to provide techniques for reducing the search space and eliminating duplicate effort to produce desirable itineraries.

### BRIEF SUMMARY OF THE INVENTION

Embodiments of the present invention address the above needs and achieve other advantages by providing systems and methods for generating itineraries in response to requests from users. In particular, embodiments of the present invention utilize an availability cache and a fare table to determine an estimated seat value for each flight that is used to generate itineraries in response to a request from a user. Thus, embodiments of the present invention are capable of generating low-fare itineraries based on an estimated seat value computed for the itineraries to more efficiently process requests from users.

In one embodiment of the present invention, a system for generating an itinerary in response to a request from a user is provided. The system includes a memory comprising a fare table, wherein the fare table includes a plurality of travel markets each associated with a fare and at least one rule (e.g., category-sequence rules). The system further includes at least one processing element configured to estimate a seat value for an itinerary including at least one flight (e.g., at least one airport O/D pair). Each estimated seat value is based on at least one fare within the fare table that satisfies at least one associated rule within the fare table.

According to various aspects of the system, the rules are associated with advanced purchase, minimum stay, maximum stay, blackout dates, day restrictions, time restrictions, combinability restrictions, and routing restrictions. The fare table may include fares associated with at least one of public, private, published, discounted, and passenger-type fares. Moreover, the system may further include a scheduling server configured for generating a plurality of outbound and inbound flights satisfying the user's request. The system could also include a cache comprising availability information for a plurality of flights. The fare table may include a plurality of fares each having an associated fare basis code, and an estimated seat value is available when the fare basis code is valid and open within the availability cache.

An additional aspect of the present invention provides a method and computer-readable medium for generating an itinerary in response to a request from a user. The method includes receiving a request (e.g., origin, destination, and dates of travel) for an itinerary from a user. The method also includes receiving availability information for at least one flight satisfying the request. Moreover, the method includes accessing a plurality of travel markets each associated with a prestored fare and at least one rule. The method further includes determining whether each fare satisfies the at least one rule, wherein each fare is associated with a flight that is available based on the availability information, and estimating a seat value for at least one itinerary comprising at least one flight. Each estimated seat value is based on at least one available fare that satisfies at least one associated rule.

Variations of the method provide that the estimating step includes estimating a seat value for each of a plurality of itineraries satisfying a request from a user and may further include ranking the seat values for the plurality of itineraries from lowest to highest value. Furthermore, the estimating step may include estimating a seat value for at least one itinerary comprising a plurality of flights based on an estimated thru fare and/or an estimated sum-of-local fare. The estimating step may include estimating a lowest seat value for the at least one itinerary, and may also include verifying at least one of an availability and a price of the at least one itinerary.

Additional aspects of the method include diversifying the at least one itinerary. For example, the diversifying step may include limiting a number of times that at least one flight is used to estimate a seat value for the at least one itinerary, or diversifying could include limiting a number of times that a carrier serving at least one flight is used to estimate a seat value for the at least one itinerary. In addition, the diversifying step may include penalizing the at least one itinerary based on undesirable service factors, or penalizing at least one itinerary that is similar to at least one other itinerary.

Further aspects of the method include receiving a plurality of inbound and outbound flights satisfying the user's request. The method may also include receiving availability information corresponding to each of the inbound and outbound flights and determining whether each available fare associated with a respective inbound and outbound flight satisfies at least one rule. Moreover, the method may include the additional step of combining at least one inbound and outbound flight, wherein each combination comprises a solution pattern of a sequence of pricing units. The estimating step may include estimating a seat value for at least one itinerary comprising each of the combination of flights.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a system according to one embodiment of the present invention;

FIG. 2 illustrates a client-server network according to one embodiment of the present invention;

FIG. 3 illustrates exemplary pricing units according to an embodiment of the present invention;

FIG. 4 depicts exemplary solution patterns according to one embodiment of the present invention; and

FIG. 5 is flowchart illustrating a process for generating an itinerary in response to a request from a user according to one embodiment of the present invention.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

Referring to the drawings and, in particular, FIG. 1, a system 10 for generating an itinerary in response to a request from a user is shown. The system 10 generally includes an availability cache 14 and a memory 12 comprising a fare table 16. One or more processing elements 18 are capable of receiving requests from users for itineraries and accessing the memory 12 and availability cache 14 to generate one or more itineraries satisfying the users' requests. The availability cache 14 stores availability information for flights, while the fare table 16 associates rules and restrictions to fares for various travel markets. Using the availability and fares, the processing element 18, such as a processing server or computing device, is capable of estimating a seat value such that the value of an itinerary may be initially determined without needing to request the information from a third party 20, such as an airline, computer reservation system (CRS), and/or global distribution system (GDS). Thus, the estimated seat value may be used to find the lowest fares for a requested itinerary such that pricing, availability, and scheduling may be later verified upon request or during the booking process.

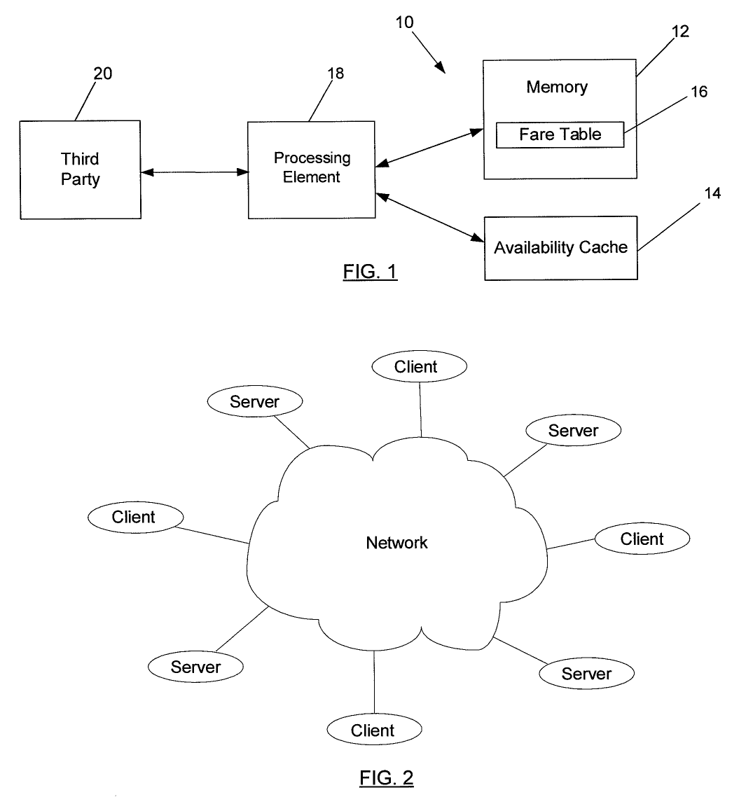

Referring now to the drawings and, in particular to FIG. 2 there is shown a network, wherein a plurality of servers and clients communicate through a network. For instance, clients may communicate with servers to obtain fare and availability information for a requested itinerary. Although reference is made herein to the airline industry, such reference is exemplary only, as the invention is applicable to various travel-related industries. For instance, embodiments of the present invention are applicable to various travel industries such as aircraft, automobile rental, rail, hotel, and the like, wherein availability and fares may be used to determine an estimated seat value for one or more itineraries.

The system 10 generates one or more itineraries in response to requests from users, where an itinerary corresponds to a proposed route of travel. As such, the term “itinerary” is not meant to be limiting and is applicable to any number of travel industries, such as those discussed above, and would include various travel information and plans for a specified route, which route could include only a single city in the context of an automobile rental or hotel reservation. In addition, each itinerary has one or more criteria associated therewith. For instance, the criteria could be origin and destination locations (O/D), dates, scheduling, fare classes for an airline flight, and service quality.

As referred to herein, the terms “client” and “server” are generally used to refer to a computer's role as a requester of data (i.e., the client) and a provider of data (i.e., the server). The client and server may communicate via a communication network, such as the Internet, an intranet, an extranet, or any other suitable network. As also used herein, the term “client” corresponds to any suitable processing element or computing device, typically a computer, a personal data assistant, mobile phone, or the like, capable of communicating with a server. Likewise, the server is generally comprised of a processing element such as a computing device having at least one or more processors and associated memory device(s) as known to those skilled in the art. For instance, the memory 12 may reside on the processing element 18, or the memory may be located on a separate processing element or be a standalone memory. In addition, the availability cache 14 and fare table 16 may reside in individual memories at the same or different locations or in the same memory. The client and server may comprise any number of conventional components but typically include a bus, central processing unit (CPU), read-only memory (ROM), random access memory (RAM), storage device, input/output controller, and network interface, and may operate at least partially under the control of one or more software programs or other applications, as all known to those skilled in the art. Any number of clients and servers may be included in the system and communicate with one another. For example, FIG. 2 illustrates that there may be a plurality of clients and servers that are capable of communicating with one another. Load balancers may be employed to distribute processing and communications activity evenly across the network.

With respect to the airline industry, a flight corresponds to one or more airport origin-destination (O/D) pairs, where each flight may include a plurality of flight segments. In particular, each flight (e.g., AZ) may include one or more inbound and outbound flight segments (e.g., AB and BZ). Thus, an itinerary may include one or more flights spanning a particular O/D pair. For instance, a user requesting a flight from Dallas to Charlotte will correspond to a flight of DFW-CLT, as well as any flight segments between DFW-CLT, such as DFW-ATL and ATL-CLT to define the complete itinerary. Although the terms “flight” and “flight segment” are used herein, the system 10 is applicable to a variety of travel industries as indicated above. Thus, the terms flight and flight segment are not meant to be limiting and may include one or more outbound, inbound, connecting, or other travel segment for a particular travel industry.

An availability cache 14 comprises a collection of availability information for a plurality of flights. The availability cache 14 stores availability information from one or more third parties 20, such as airlines, computer reservation systems (CRSs), and/or global distribution systems (GDSs). The availability information may include various information indicative of availability for a particular flight, such as flight numbers, dates, times, seat count, etc. Availability may be based on the opening or closing of a booking class or code. For instance, booking classes Q, Y, and F are used to represent economy/coach class, business class, and first class, respectively. In particular, each fare has a fare basis code (FBC) such as Y26 or QA7NR. In general, the first letter of a FBC is the booking class that a fare may use. Exceptions on booking code are specified by the rule data associated with the fare to allow a different class or multiple classes to be used. For domestic travel, booking code exceptions are rare for economy fares and straightforward to process. A fare is available for a specific flight if a valid booking code for the fare is open on the flight.

Moreover, the availability cache 14 may be updated periodically. For example, a processing element 18 may request updates to the availability information periodically, poll a third party 20 (e.g., airline, CRS, and/or GDS), or the availability information may be provided directly from a third party (e.g., airline, CRS, and/or GDS) and updated automatically. Thus, the availability information is temporarily stored in the availability cache 14 and may be accessed without needing to request availability information from the third party 20 (e.g., airline, CRS, and/or GDS) in real time, even though the availability information in the availability cache may be somewhat out-of-date. The availability information may be stored in a variety of formats in order to facilitate the accessibility of the information, such as organization by date ranges, markets, flights, etc.

The fare table 16 includes fares and rules for a plurality of travel markets, wherein a travel market includes more or more travel segments. The fare table 16 may include various rules associated with each fare (e.g., advanced purchase, maximum/minimum stay, date/time restrictions, etc.), combinability rules, and/or routing rules. Combinability rules specify how a fare can be combined with other fares, while routing rules specify whether the flight must be nonstop or connecting and, if so, the connecting cities. A fare is applicable for a travel market if the fare satisfies each of the rules associated with the flight. The fare table 16 may include various data organized in a tabular format that is stored in the memory 12, and one or more portions of the fare table may be stored in a separate memory or particular location within the memory for faster access.

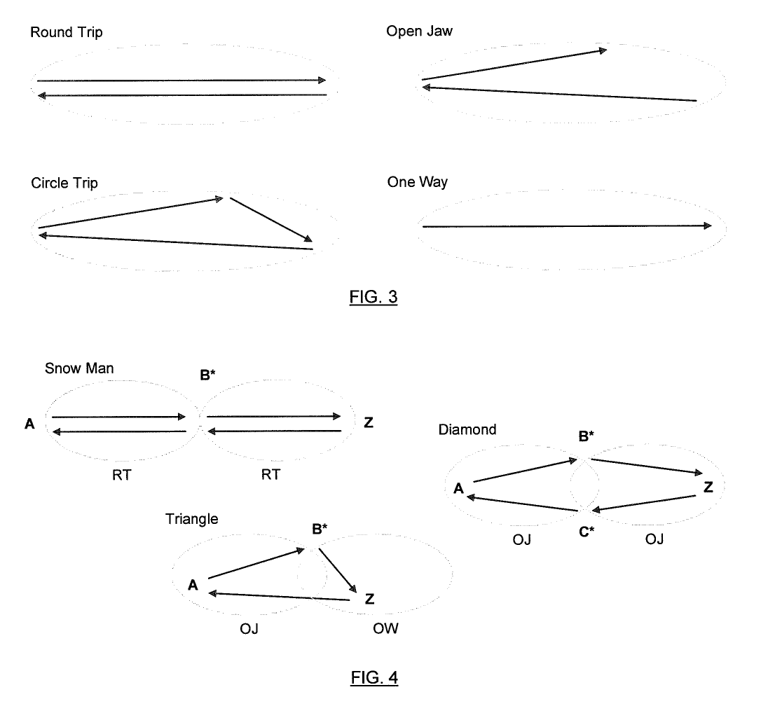

With respect to combinability rules, fares can be encapsulated into various pricing unit types such as round trip, open jaw, circle trip, and one way. As shown in FIG. 3, a round trip pricing unit includes a direct connection between an O/D for the departure and return flights. The open jaw pricing unit includes a departure flight and at least one additional flight, but the final flight does not return to the origin location. In addition, the circle trip pricing unit includes a departure flight and a plurality of additional flights, with the final flight returning to the origin location. The one-way pricing unit includes a single O/D.

A combination of pricing units defines a solution pattern, such as those shown in FIG. 4. For instance, a “snow man” solution pattern includes a pair of roundtrip pricing units; a “diamond” solution pattern includes a pair of open jaw pricing units; and a triangle solution pattern includes an open jaw pricing unit and a one-way pricing unit. Thus, a solution pattern encapsulates all of the fares describing a journey (i.e., a plurality of flights) and defines constraints for producing solutions. In this regard, the constraints are driven by the pricing unit types that group the fares that span the journey. In other words, the fares are grouped into pricing units, and the pricing units are grouped into solution patterns.

The data structure of the fare table 16 includes the association of category-rules to specific fares. For example, Category 1 corresponds to Eligibility, Category 2 corresponds to Day of Week, Category 3 corresponds to Seasons, Category 5 corresponds to Advanced Purchase, Category 6 corresponds to Minimum Stay, Category 7 corresponds to Maximum Stay, Category 9 corresponds to Transfers, Category 10 corresponds to Combinability Restrictions, Category 11 corresponds to Blackouts, Category 14 corresponds to Travel Restrictions, and Category 15 corresponds to Sales Restrictions. For example, a rule falling within Category 2 could be fare class X is only valid on Tuesday before noon. Categories within the fare table 16 are typically organized as a rule tree. As known to those skilled in the art, the Airline Tariff Publishing Company (ATPCO) includes a plurality of more detailed rules, designated Record 3s (R3s), associated with and further defining each higher level rule, designated Record 2 (R2), where the R3s are organized as a sequence string of rule fragments in a rule tree for each R2. For example, the category rule sequence string may be represented as a binary predicate tree where the terminal nodes are the R3s that are evaluation functions.

The fare table 16 also includes a collection of fares that each corresponds to a travel market. As used herein, fares shall refer to any pricing or fare information, be it in the context of air fares, car rental fees, etc. The fare table 16 may include public, private, published, discounted, and/or passenger-type fares. The fares and rules, may be provided by third-party vendors 20 such as ATPCO. The fare table 16 is built and maintained based on changing fares. Thus, as with the availability cache 14, the fare table 16 may be updated periodically by polling or otherwise requesting updates with a processing element, or updates for fares and rules may be provided automatically to the fare table.

It is understood that the aforementioned discussion of the availability cache 14 and fare table 16 is not meant to be limiting, as the cache and fare table could include various information in various formats. For example, the availability cache 14 and fare table 16 may include availability information and fares, respectively, for individual flights and/or complete itineraries, and the availability and fares may be sorted in a variety of manners such as by fare class or specific market. As indicated above, the availability cache 14 and fare table 16 may be used in conjunction with various travel industries such that each may contain information specific to each travel industry and be organized in the same general manner. In addition, the fare table 16 generally includes rules/restrictions/constraints and corresponding fares for travel markets. The fare table 16 could include one or more specific category-sequence rules (e.g., Categories 1, 2, 3, 5, 6, 7, 11, 14, and 15) to parse out one or more flights to limit the number of itineraries that are processed. Furthermore, the fare table 16 could include fares for respective travel markets that correspond to a fare or booking class. Additionally, all rules need not necessarily be stored in the fare table 16, as rules such as routing restrictions may be linked from a separate location and not physically stored in the fare table. As described above, the availability cache 14 and fare table 16 may be updated such that old data may be purged and updated data added. Thus, available memory may be increased, while unnecessary processing of outdated data may be eliminated. Moreover, the availability cache 14 and fare table 16 could provide feedback to help guide future requests from users. For instance, the fare table 16 could manage a history of itineraries satisfying users' requests as a guide for generating future solutions or statistics. Furthermore, although denominated as a table throughout, the fare table 16 need not necessarily be organized or structured in a traditional tabular manner, such as in an n X m array of contiguous memory locations. Instead, the table is intended to more broadly refer to any database or memory organizational structure from which associations between different elements can be drawn, such as between category-sequences and fares in a fare table.

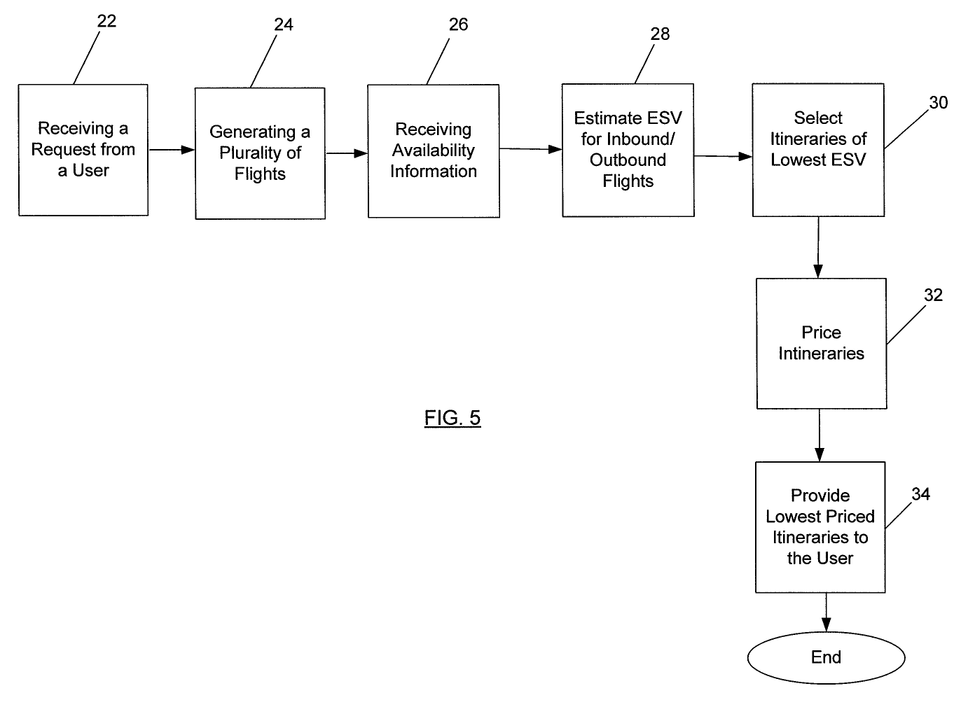

With respect to the typical processing flow according to one embodiment of the present invention, FIG. 5 illustrates that a user typically provides one or more criteria in a request for an itinerary (block 22). For example, the request could include origin and destination locations (O/D), dates, fare classes for an airline flight, and service quality. Based on the request, a plurality of inbound and outbound flights satisfying the user's request are generated (block 24), typically by a scheduling server. For instance, in response to the user's request for a flight from Dallas to New York, flights between Dallas and New York, such as DFW-CLT and CLT-NYC for one or more carriers may be generated. Any number of inbound and outbound flights may be generated. For example, 1000 inbound and 1000 flights could be generated. The inbound and outbound flights are sent to the availability cache 14, and availability information associated with the flights is located (block 26). The number of flights and corresponding availability to consider for a particular request can be adjusted based on various criteria, such as complex trip (i.e., two or more destinations), alternate dates, calendar (i.e., range of dates), and alternate destination shopping.

The fare table 16 may be accessed to determine if the fares are applicable so that an estimated seat value (ESV) may be estimated for one or more of the applicable fares (block 28). Thus, once the availability for one or more flights has been provided, one or more available fares within the fare table 16 are located. For example, an available fare includes a valid and open booking code. Those fares that do not include a valid and open booking code may be skipped. In addition, an applicable fare satisfies one or more rules within the fare table 14. For example, a request for a flight within 14 days of departure may not satisfy an advance purchase requirement, while one round trip flight may not be combinable with another round trip flight despite the availability of the flights. Those inbound and outbound flights having associated fares that satisfy the associated rules within the fare table 16 and that are combinable are combined to determine the ESV for each itinerary. The accuracy of ESV is influenced by several factors, such as seat availability, the scope of the fares, the extent of the fare rule data, and the application of fare rules. The ESVs to be considered may be limited to a pre-determined number of itineraries (e.g., 500 to 1000 itineraries).

For a nonstop flight, the ESV is the value of the lowest fare that is available and applicable for the flight. For a two-segment connecting flight, the ESV has two components: the thru ESV and the sum-of-local (SOLO) ESV. If the connecting flight is online (i.e., a single airline), the thru ESV is computed by using the thru fares; otherwise, the connecting flight is interline (i.e., multiple airlines) and thru fares may not be used. The SOLO ESV is the sum of ESVs for each flight by viewing a flight as a nonstop flight. The ESV for a plurality of flights is the minimum of its thru ESV and SOLO ESV. The same concept extends to connecting flights with three or more flight segments where one may use an intermediate thru fare to cover consecutive flight segments of the same carrier. For carriers that use O/D control of seat availability, a flight may have multiple availabilities on the flight segment and O/D levels. For example, a connecting flight includes local and thru availability, while a nonstop flight only includes local or thru availability (i.e., local and thru availability are the same). In addition, the thru ESV includes thru availability, while the SOLO ESV includes local availability. Accordingly, the thru ESV and SOLO ESV are based on a particular type of availability.

The applicable pricing units for an ESV are determined on the basis of the entire itinerary. For example, for a round-trip itinerary with AA outbound and CO inbound, a one-way pricing unit may be used for the outbound flight using AA's one-way fares and another one-way pricing unit may be used for the inbound flight using CO's one-way fares. If both the outbound and inbound flights use AA flights, we may use a round-trip pricing unit using AA's round-trip fares. Hence, given an outbound flight alone, all applicable pricing units for this outbound flight cannot be determined when the inbound flight is not provided. The ESV for an itinerary is the minimum ESV over all applicable combinations of pricing units for the itinerary. To permit the consideration of pricing units at the itinerary level, for each flight, multiple ESVs may be computed based on round-trip fares, one-way fares, or a combination of both in case of a SOLO ESV. When an outbound flight and an inbound flight are combined to form an itinerary, ESV values from the flights may be used to determine the ESV for the applicable pricing units.

The ESV for an itinerary is an estimate for the lowest fare amount that can be sold for the itinerary. In general, an itinerary with a low ESV implies that the itinerary is likely to have an actual low fare. For a low-fare search, the strategy of determining the ESV is to select a set of itineraries with low ESVs (block 30) and price these itineraries without having to price all of the other possibilities (block 32). Thus, the ESV is only an estimated fare such that the itinerary subsequently is priced to determine an actual fare and availability is verified to ensure that the itinerary is available. A plurality of priced itineraries satisfying the user's request may be ranked based on a variety of factors, such as lowest to highest ESVs, and provided to the user (block 34).

Therefore, once the ESVs for all available and applicable itineraries have been determined, the actual fares, schedules, and availability may be requested and verified for each itinerary. For example, a dynamic schedule service may be employed to return a schedule for the itinerary having specified date ranges. In addition, actual availability may be requested from a third party 20 such as the airline, CRS, and/or GDS, while fares may be requested from a third-party vendor, such as ATPCO. Once all rules have been satisfied and scheduling verified for connecting schedules, complete itineraries are priced and provided to the user. Optionally, the priced itineraries are sorted from lowest to highest price for the user.

As an ESV is only an estimate of the actual fare, techniques may be utilized to ensure that the itineraries with the lowest fares are among the selected itineraries. For example, an outbound flight with low ESV can be used to form many itineraries of low ESV. The inaccuracy of an ESV for this particular outbound flight would affect all the itineraries using this flight. To reduce the impact of a single flight, a limit may be placed on how many itineraries can use the same flight. Similarly, the number of itineraries by the same carrier may be limited. For a trade-off between fare and service quality, a cost-function may be determined for itineraries that adds penalty points to the ESV for undesirable service factors such as long flight time, flight stops, and inconvenient schedule. Itineraries may then be selected based on a combination of the lowest ESVs and the associated cost-function. These lowest-ESV itineraries can cover a wide spectrum of itinerary options in terms of fares and service quality.

However, the diversity of itinerary options may not necessarily be realized as a by-product from the fare-quality trade-off. Because the cost-function is applied to individual flights, it is possible that the flights with the lowest ESVs may be undesirable, such as flights offered by the same carrier or having early-morning departure. One mechanism to further ensure diversity is to track the itineraries that have the lowest ESVs and that are already selected such that those itineraries that are similar to those selected itineraries may be penalized and, therefore, have a lower likelihood of being selected.

The selection of itineraries may also build in a trade-off between the service quality and the ESV amount. By balancing the service quality, diversity, and price, ESVs can be used to identify itineraries with a wide spectrum of desirability for the users. As a result, ESVs can serve as a unifying and flexible framework for providing itinerary options of “value” to travelers. In general, high-quality and diverse flights may be provided as input to each ESV in order to provide itineraries of value to the user, and the strategy of generating a large number of flights, on the order of thousands for each travel direction, is likely to provide a comprehensive set of flights.

For example, ESVs may be used to select scheduled-oriented options from its input schedules while overcoming the deficiencies of a conventional schedule led path (SLP), such as by not limiting the number of thru-fares considered and producing options with trade-offs in price and service. One component to select schedule-led options may be a penalty scheme that assigns to each flight a cost that combines an estimated fare price and the penalty points for a broad set of schedule-related factors. Flight options may be chosen from lowest to highest base on cost. This penalty scheme may provide the framework for the price-service-value trade-off. A second component may be a guarantee for carrier and service-level diversity. The selection process may have multiple passes to implement the diversity and tradeoff.

According to one aspect, the penalty scheme may include penalty values, in dollar amount, for flight stop, travel duration, and deviation from requested departure or arrival times. For example, each stop may be given a penalty of $50.00. System defaults may be set for the penalty values. The actual penalty values can be set individually for each request depending on the value to the user, which may be specified or inferred. Moreover, other factors (e.g., service factors in the schedule) may be reflected in the penalty scheme such as preferred carrier, aircraft type, interline trips, and connecting cities/region for weather-related reasons. For a given flight, the total penalty points may be calculated, and the cost of a flight may be the sum of the fare price estimated by ESV and the penalty points.

According to an additional aspect, diversity is utilized for selecting scheduled-oriented options from its input schedules. For example, the diversity parameters may include carrier, service-level, and schedule-density guarantees. If a carrier provides nonstop service, then a guaranteed number, usually a system-default value, of the nonstop options by this carrier may be selected. These options are of the lowest cost among the similar options according to the penalty scheme. Similarly, if a carrier provides one-stop service, then a guaranteed number of one-stop trips, summing over both directions, by this carrier may be selected. To ensure the diversity at the flight level, there may be a limit on the repeated use of the same flight in different options. The diversity may also take a carrier's schedule density into account. Based on the outbound flights, the schedule density (e.g., expressed as a percentage) may be computed for each carrier that provides online service. For these carriers, the percentage of flights by each carrier in the schedule-oriented options may fall within a range of the carrier's schedule percentage.

In addition to the scheduled-oriented options, ESVs may be used to select a certain number of low-fare options based on fare price. The selection of low-fare options may be carried out after the scheduled-oriented options are chosen. The chosen scheduled-oriented options may be skipped in the low-fare selection to avoid duplication. With the subsequent selection of low-fare options in place, the scheduled-oriented options may be restricted to options having high-quality schedules. In particular, two-stop flights by the carriers with nonstop or one-stop service may not be considered as scheduled-oriented options, as a two-stop flight is typically undesirable service-wise in the presence of nonstop or one-stop service. The cheaper two-stop flights may be chosen as low-fare options instead.

For the purpose of runtime reduction, a cut-off mechanism may be based on a cost limit and used in the scheduled-oriented selection as well as in the low-fare selection. A cut-off multiplier (e.g., between 1.5 and 2.0) may be given as a parameter. The selection may terminate when the remaining options have a cost greater than the product of the cut-off multiplier and the cost of the lowest-cost options identified. For example, if the lowest-cost option has a cost of $200 and with a cut-off multiplier of 1.5, the selection terminates when the cost reaches $300. This cut-off mechanism may have a significant impact in reducing the runtime when the selection space is large. For scheduled-oriented selection, a cut-off may be used for selecting interline options where an outbound flight by one carrier can be paired with any inbound flight by another carrier.

It is understood that the various features described above pertaining to the processes involved in generating one or more itineraries satisfying a user's request is not meant to be limiting. For example, the performance of the various steps may be carried out in different chronological steps. Thus, the fares may be accessed from the fare table 16 prior to accessing the availability information from the availability cache 14. In addition, various other steps could be performed, such as performing pricing unit based minimum fare checks and/or performing final journey validations including remaining minimum fare checks. In addition, various steps could be performed concurrently, such as locating flights that are available and satisfy the rules and then comparing the flights to determine ESVs for common flights that are both available and satisfy the rules. Furthermore, the system 10 could be set up such that only subscribers (e.g., internet websites) have access or limited access to the availability and fares, or the subscribers could sign up to receive a particular subset of availability and fares (e.g., information associated with a particular carrier).

According to one aspect of the present invention, the system generally operates under control of a computer program product. The computer program product for performing the methods of embodiments of the present invention includes a computer-readable storage medium, such as the memory device associated with a processing element, and computer-readable program code portions, such as a series of computer instructions, embodied in the computer-readable storage medium. In this regard, FIG. 7 is a control flow diagram of a method and program product according to one embodiment of the invention. It will be understood that each block or step of the control flow diagram, and combinations of blocks in the control flow diagram, can be implemented by computer program instructions. These computer program instructions may be loaded onto a processing element, such as a computer, server, or other programmable apparatus, to produce a machine, such that the instructions which execute on the processing element create means for implementing the functions specified in the block(s) or step(s) of the control flow diagram. These computer program instructions may also be stored in a computer-readable memory that can direct the processing element to function in a particular manner, such that the instructions stored in the computer-readable memory produce an article of manufacture including instruction means which implement the function specified in the block(s) or step(s) of the control flow diagram. The computer program instructions may also be loaded onto the processing element to cause a series of operational steps to be performed on the processing element to produce a computer implemented process such that the instructions which execute on the processing element provide steps for implementing the functions specified in the block(s) or step(s) of the control flow diagram.

Accordingly, blocks or steps of the control flow diagram support combinations of means for performing the specified functions, combinations of steps for performing the specified functions, and program instruction means for performing the specified functions. It will also be understood that each block or step of the control flow diagram, and combinations of blocks or steps in the control flow diagram, can be implemented by special purpose hardware-based computer systems which perform the specified functions or steps, or combinations of special purpose hardware and computer instructions.

Embodiments of the present invention may provide several advantages. In particular, the system of one embodiment of the present invention may provide a more efficient, extensible, and manageable air shopping capability across a variety of functional needs including domestic, international, alternate dates, alternate city, and calendar. In particular, the system may reduce the search space through the organization of availability, rules, and fares. Using a cache of availability information and a fare table including various fares and rules/restrictions, only those flights that are available and satisfy one or more category rules are further processed, which eliminates the need to initially determine itineraries or fares in real time. As such, the system of one embodiment of the present invention may effectively minimize the total quantity of work required for each request, maximize the number of potential solutions, and raise the potential for overall quality responses since a substantial portion of the processing has already been completed. Furthermore, the ESV allows itineraries to be more efficiently processed and returned to the user prior to pricing the itineraries and determining the actual availability or scheduling. Thus, embodiments of the present invention do not need to first search for itineraries based on the cheapest fares and find associated schedules (i.e., a fare led search) or search for the cheapest combination of flights for a given schedule (i.e., a schedule-led search). As such, the system is capable of estimating a seat value within a limited search space of availability and fares. In addition, embodiments of the present invention may employ various safeguards to aid in diversifying itineraries and ensuring that the ESVs are accurate when the itineraries are later selected for booking.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for generating an itinerary in response to a request from a user comprising:
a memory comprising a fare table, wherein the fare table comprises a plurality of travel markets each associated with a fare and at least one rule; and
at least one processing element configured to estimate a seat value for at least one itinerary comprising at least one flight in response to a request from a user, wherein each estimated seat value is based on at least one fare within the fare table that satisfies at least one associated rule within the fare table.

2. The system of claim 1, wherein each flight comprises at least one airport origin-destination pair.

3. The system of claim 1, wherein each rule comprises a category-sequence rule.

4. The system of claim 1, wherein the fare table comprises a plurality of rules associated with at least one of advanced purchase, minimum stay, maximum stay, blackout dates, day restrictions, time restrictions, combinability restrictions, and routing restrictions.

5. The system of claim 1, wherein the fare table comprises a plurality of fares associated with at least one of public, private, published, discounted, and passenger-type fares.

6. The system of claim 1, further comprising a scheduling server configured for generating a plurality of outbound and inbound flight satisfying the user's request.

7. The system of claim 1, further comprising a cache comprising availability information for a plurality of flights.

8. The system of claim 7, wherein the fare table comprises a plurality of fares each having an associated fare basis code, and wherein a fare is available when the fare basis code is valid and open within the availability cache.

9. A method for generating an itinerary in response to a request from a user comprising:
receiving a request for an itinerary from a user;
receiving availability information for at least one flight satisfying the request;
accessing a plurality of travel markets each associated with a prestored fare and at least one rule;
determining whether each fare satisfies the at least one rule, each fare associated with a flight that is available based on the availability information; and
estimating a seat value for at least one itinerary comprising at least one flight, wherein each estimated seat value is based on at least one available fare that satisfies at least one associated rule.

10. The method of claim 9, wherein estimating comprises estimating a seat value for each of a plurality of itineraries satisfying a request from a user.

11. The method of claim 10, further comprising ranking the estimated seat values for the plurality of itineraries from lowest to highest value.

12. The method of claim 9, wherein estimating comprises estimating a seat value for at least one itinerary comprising a plurality of flights based on at least one of an estimated thru fare and an estimated sum-of-local fare.

13. The method of claim 9, wherein estimating comprises estimating a lowest seat value for the at least one itinerary.

14. The method of claim 9, further comprising verifying at least one of an availability and a price of the at least one itinerary.

15. The method of claim 9, wherein receiving comprises receiving at least one of origin, destination, and dates of travel from a user.

16. The method of claim 9, further comprising diversifying the at least one itinerary.

17. The method of claim 16, wherein diversifying comprising limiting a number of times that at least one flight is used to estimate a seat value for the at least one itinerary.

18. The method of claim 16, wherein diversifying comprises limiting a number of times that a carrier serving at least one flight is used to estimate a seat value for the at least one itinerary.

19. The method of claim 16, wherein diversifying comprises penalizing the at least one itinerary based on undesirable service factors.

20. The method of claim 16, wherein diversifying comprises penalizing at least one itinerary that is similar to at least one other itinerary.

21. The method of claim 9, further comprising receiving a plurality of inbound and outbound flights satisfying the user's request.

22. The method of claim 21, wherein receiving availability information comprises receiving availability information corresponding to each of the plurality of inbound and outbound travel flights.

23. The method of claim 22, wherein determining comprises determining whether each available fare associated with a respective inbound and outbound flight satisfies at least one rule.

24. The method of claim 23, further comprising combining at least one inbound and outbound flight, wherein each combination comprises a solution pattern of a sequence of pricing units.

25. The method of claim 24, wherein estimating comprises estimating a seat value for at least one itinerary comprising each of the combination of flights.

26. The method of claim 9, wherein determining whether each fare is available comprises determining whether a fare basis code associated with each fare is valid and open.

27. A computer-readable medium containing instructions for controlling a computer system to perform a method for generating an itinerary in response to a request from a user comprising:
receiving a request for an itinerary from a user;
receiving availability information for at least one flight satisfying the request;
accessing a plurality of travel markets each associated with a prestored fare and at least one rule;
determining whether each fare satisfies the at least one rule, each fare associated with a flight that is available based on the availability information; and
estimating a seat value for at least one itinerary comprising at least one flight, wherein each estimated seat value is based on at least one available fare that satisfies at least one associated rule.

28. The computer-readable medium of claim 27, wherein estimating comprises estimating a seat value for each of a plurality of itineraries satisfying a request from a user.

29. The computer-readable medium of claim 28, further comprising ranking the seat values for the plurality of itineraries from lowest to highest value.

30. The computer-readable medium of claim 27, wherein estimating comprises estimating a seat value for at least one itinerary comprising a plurality of flights based on at least one of an estimated thru fare and an estimated sum-of-local fare.

31. The computer-readable medium of claim 27, wherein estimating comprises estimating a lowest seat value for the at least one itinerary.

32. The computer-readable medium of claim 27, further comprising verifying at least one of an availability and a price of the at least one itinerary.

33. The computer-readable medium of claim 27, wherein receiving comprises receiving at least one of origin, destination, and dates of travel from a user.

34. The computer-readable medium of claim 26, further comprising diversifying the at least one itinerary.

35. The computer-readable medium of claim 34, wherein diversifying comprising limiting a number of times that at least one flight is used to estimate a seat value for the at least one itinerary.

36. The computer-readable medium of claim 34, wherein diversifying comprises limiting a number of times that a carrier serving at least one flight is used to estimate a seat value for the at least one itinerary.

37. The computer-readable medium of claim 34, wherein diversifying comprises penalizing the at least one itinerary based on undesirable service factors.

38. The computer-readable medium of claim 34, wherein diversifying comprises penalizing at least one itinerary that is similar to at least one other itinerary.

39. The computer-readable medium of claim 27, further comprising receiving a plurality of inbound and outbound flights satisfying the user's request.

40. The computer-readable medium of claim 39, wherein receiving availability information comprises receiving availability information corresponding to each of the plurality of inbound and outbound flights.

41. The computer-readable medium of claim 40, wherein determining comprises determining whether each available fare associated with a respective inbound and outbound flight satisfies at least rule.

42. The computer-readable medium of claim 41, further comprising combining at least one inbound and outbound flight, wherein each combination comprises a solution pattern of a sequence of pricing units.

43. The computer-readable medium of claim 42, wherein estimating comprises estimating a seat value for at least one itinerary comprising each of the combination of flights.

44. The computer-readable medium of claim 27, determining whether each fare is available comprises determining whether a fare basis code associated with each fare is valid and open.
